(19) United States
(12) Patent Application Publication
(10) Pub. No.: US 2019/0304123 A1
(43) Pub. Date: Oct. 3, 2019

(54) IDENTIFICATION APPARATUS, IDENTIFICATION METHOD, AND NON-TRANSITORY RECORDING MEDIUM STORING IDENTIFICATION PROGRAM

(71) Applicant: PANASONIC INTELLECTUAL PROPERTY MANAGEMENT CO., LTD., Osaka (JP)

(72) Inventors: Hiroshi IWAI, Osaka (JP); Osamu SHIBATA, Hyogo (JP); Tetsuro OKUYAMA, Osaka (JP)

(73) Assignee: PANASONIC INTELLECTUAL PROPERTY MANAGEMENT CO., LTD., Osaka (JP)

(21) Appl. No.: 16/365,301

(22) Filed: Mar. 26, 2019

(30) Foreign Application Priority Data
Mar. 27, 2018 (JP) 2018-060306

(51) Int. Cl. G06T 7/70; G06T 7/55; G06K 9/00

(52) U.S. Cl. CPC G06T 7/70; G06K 9/00523; G06T 7/55

(57) ABSTRACT

In order to accurately identify a boundary between an object and a space, an identification apparatus includes circuitry that receives first distance image information obtained by imaging an object from a first point, using an imaging apparatus and second distance image information obtained by imaging the object from a second point different from the first point, using the imaging apparatus, derives first distance information from the first point to a plurality of feature points of the object based on the first distance image information and derives second distance information from the second point to the plurality of feature points based on the second distance image information, identifies a boundary between the object and a space based on the first distance information and the second distance information, and outputs an identification result from the identifying to an external apparatus.

### TECHNICAL FIELD

The present disclosure relates to an identification apparatus, an identification method, and a non-transitory recording medium storing an identification program.

### BACKGROUND ART

Conventionally, a system for generating a three-dimensional model using two cameras is known.

### CITATION LIST

### Patent Literature

### PTL 1

### Japanese Patent Application Laid-Open No. 2016-162034

### SUMMARY

### Technical Problem

However, recently, an automated parking system has been widespread. It is important to accurately detect whether or not there is a space for parking a vehicle in the automated parking system. Therefore, it is required to accurately identify a boundary between a vehicle (object) to be parked and a space.

In addition, a distance measurement method which uses a time of flight distance measurement method (referred to as a “time of flight (TOF) method” below) is known. A distance from subject vehicle to be parked to the parked vehicle is calculated by using the TOF method, and in a case where it is intended to identify a boundary between the parked vehicle and the space, it is important to accurately estimate the distance from subject vehicle to be parked to the parked vehicle.

A purpose of the present disclosure is to accurately identify a boundary between an object and a space.

### Solution to Problem

One aspect of the present disclosure is an identification apparatus, including: circuitry that receives first distance image information obtained by imaging an object from a first point, using an imaging apparatus, and second distance image information obtained by imaging the object from a second point different from the first point, using the imaging apparatus; derives first distance information from the first point to a plurality of feature points of the object based on the first distance image information and derives second distance information from the second point to the plurality of feature points based on the second distance image information; identifies a boundary between the object and a space based on the first distance information and the second distance information; and outputs an identification result from the identifying to an external apparatus.

One aspect of the present disclosure may be any of a method and a non-transitory recording medium storing a program.

### Advantageous Effects

According to the present disclosure, it is possible to accurately identify a boundary between an object and a space.

### BRIEF DESCRIPTION OF DRAWINGS

FIG. 1 is a block diagram illustrating a configuration of a drive support system including an identification apparatus;

FIG. 2A is a diagram illustrating states of emission light and return light;

FIG. 2B is a diagram illustrating an outline of the time of flight distance measurement method;

FIG. 3 is a flowchart illustrating an example of distance measurement processing and identification processing;

FIG. 4 is a diagram illustrating an example of a distance image obtained by imaging a parked vehicle using an imaging apparatus;

FIG. 5A is a diagram illustrating a state where a space adjacent to one parked vehicle is detected;

FIG. 5B is a diagram illustrating a state where the space adjacent to one parked vehicle is detected;

FIG. 5C is a diagram illustrating a state where the space adjacent to one parked vehicle is detected;

FIG. 5D is a diagram illustrating a state where the space adjacent to one parked vehicle is detected;

FIG. 5E is a diagram illustrating a state where the space adjacent to one parked vehicle is detected;

FIG. 5F is a diagram illustrating a state where the space adjacent to one parked vehicle is detected;

FIG. 6A is a diagram illustrating a state where a space between two parked vehicles is detected;

FIG. 6B is a diagram illustrating a state where the space between two parked vehicles is detected;

FIG. 6C is a diagram illustrating a state where the space between two parked vehicles is detected;

FIG. 6D is a diagram illustrating a state where the space between two parked vehicles is detected;

FIG. 6E is a diagram illustrating a state where the space between two parked vehicles is detected;

FIG. 6F is a diagram illustrating a state where the space between two parked vehicles is detected;

FIG. 6G is a diagram illustrating a state where the space between two parked vehicles is detected;

FIG. 6H is a diagram illustrating a state where the space between two parked vehicles is detected;

FIG. 6I is a diagram illustrating a state where the space between two parked vehicles is detected;

FIG. 6J is a diagram illustrating a state where the space between two parked vehicles is detected;

FIG. 6K is a diagram illustrating a state where the space between two parked vehicles is detected; and

FIG. 6L is a diagram illustrating a state where the space between two parked vehicles is detected.

### DESCRIPTION OF EMBODIMENTS

Hereinafter, surrounding monitoring system 1 mounted with identification apparatus 100 according to one embodiment of the present disclosure will be described in detail with reference to the drawings. Embodiment which will be described below are merely examples and the present disclosure is not limited by the embodiments.

Surrounding monitoring system 1 is mounted on, for example, vehicle V. Hereinafter, surrounding monitoring system 1 will be continuously described as a system for monitoring a side of vehicle V, but may monitor portions (the front, the rear, or whole circumferential directions) other than the side of vehicle V.

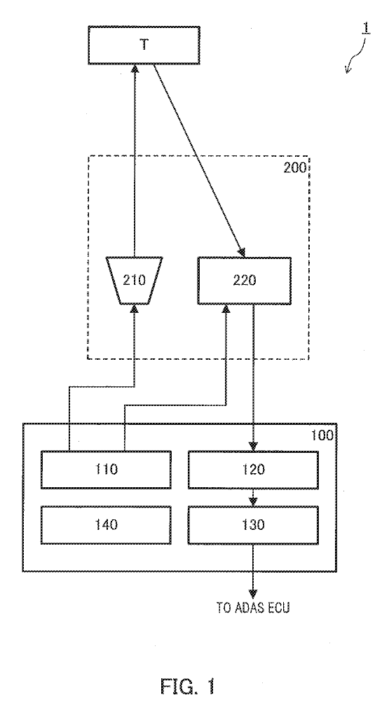

As illustrated in FIG. 1, surrounding monitoring system 1 includes imaging apparatus 200 in which light source 210 and image sensor 220 are integrated, and identification apparatus 100.

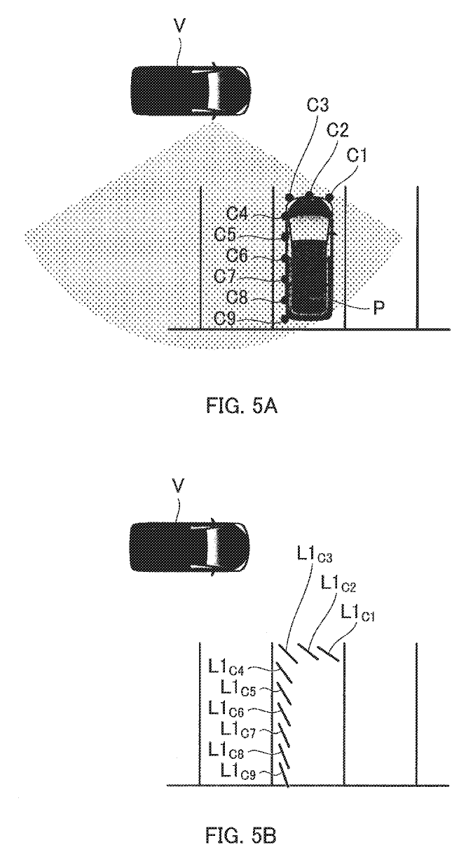

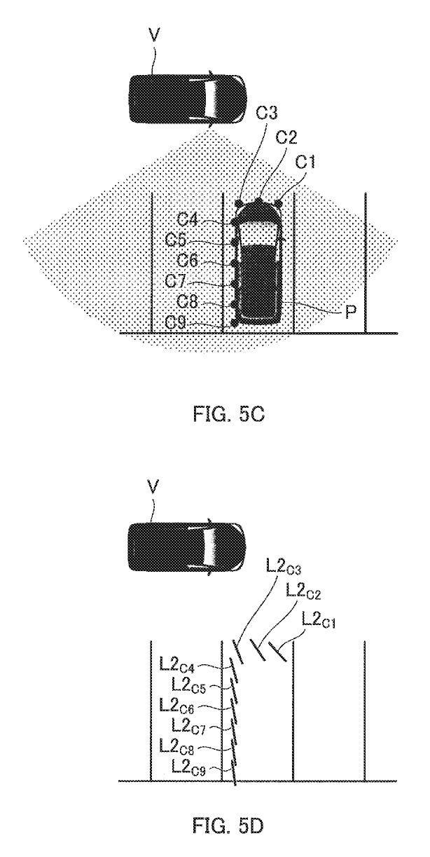

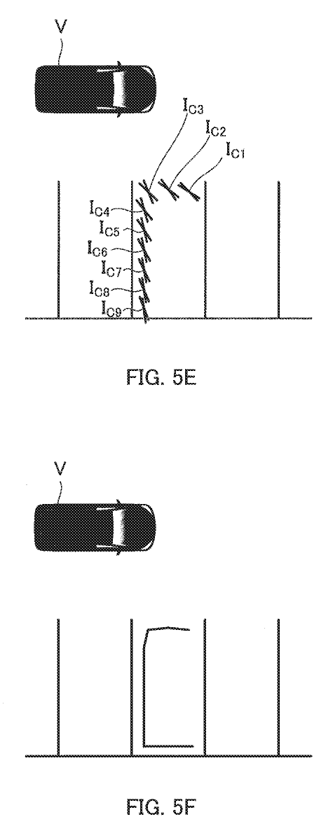

Imaging apparatus 200 is attached to, for example, a side surface of vehicle V in a direction orthogonal to a travel direction of vehicle V (refer to FIG. 5A). An attachment location of imaging apparatus 200 is not limited to the side surface of vehicle V. In addition, an attachment direction of imaging apparatus 200 is not limited to the direction orthogonal to the travel direction of vehicle V.

Light source 210 is attached to emit invisible light (for example, infrared light or near infrared light) having a period of a pulse or a sinusoidal wave toward an imaging range.

Image sensor 220 is, for example, a complementary metal oxide semiconductor (CMOS) image sensor, and is attached approximately at the same location as light source 210 such that an optical axis thereof extends in the direction orthogonal to the travel direction of vehicle V.

Identification apparatus 100 is, for example, an electronic control unit (ECU), and includes an input terminal, an output terminal, a processor, a program memory, and a main memory mounted on a control board in order to control lateral monitoring of vehicle V.

The processor executes a program stored in the program memory using the main memory, processes various signals received through the input terminal, and outputs various control signals to light source 210 and image sensor 220 through the output terminal.

Identification apparatus 100 functions as imaging controller 110, distance measurer 120, identifier 130, storage section 140, and the like by executing of the program using the processor as illustrated in FIG. 1.

Imaging controller 110 controls various conditions (specifically, a pulse width, a pulse amplitude, a pulse interval, pulse number, and the like) of the light emitted from light source 210 and outputs a control signal to light source 210.

In addition, the imaging controller 110 controls various conditions (specifically, exposure time, exposure timing, the number of times of exposure, and the like) of the light reception of the return light to image sensor 220 and outputs a control signal to peripheral circuits included in image sensor 220.

Image sensor 220 outputs an infrared image signal and a distance image signal relating to an imaging range to identification apparatus 100 at a predetermined cycle (predetermined frame rate) according to the exposure light control and the like described above.

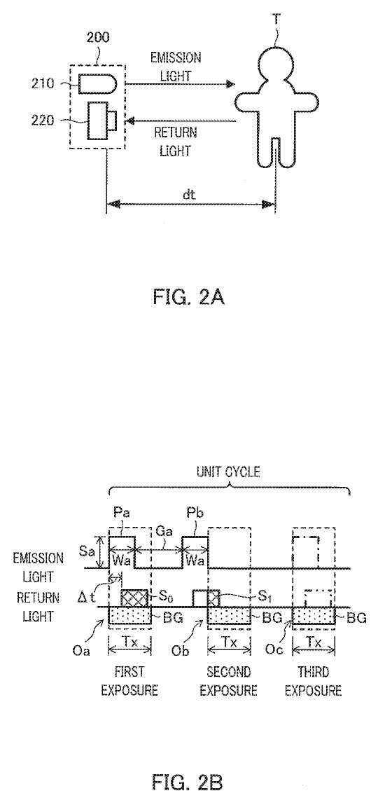

Each pixel for a distance image output from image sensor 220 to identification apparatus 100 includes distance information derived by a TOF method. FIG. 2A is a schematic diagram illustrating states of emission light and return light when distance dt to target T is derived.

Here, an example of distance measurement using the TOF method will be described. As illustrated in FIG. 2B, the emission light from light source 210 includes at least one set of first pulse Pa and second pulse Pb during a unit cycle. The pulse interval (that is, time from a falling edge of first pulse Pa to a rising edge of second pulse Pb) is Ga. It assumed that an amplitude of the pulse is Sa, and a width of the pulse is Wa.

Image sensor 220 is controlled to perform exposure at timing based on the emission timing of first pulse Pa and second pulse Pb by imaging controller 110. Specifically, as exemplified in FIG. 2B, image sensor 220 performs a first exposure, a second exposure, and a third exposure for the invisible light obtained by reflecting back an emission light from light source 210 by target T of an imaging range.

The first exposure starts simultaneously with rise of the first pulse Pa and ends after preset exposure time Tx in relation to the emission light from light source 210. The first exposure aims to receive return light components for first pulse Pa.

Output Oa of image sensor 220 by the first exposure includes return light component S₀ with a hatched diagonal lattice shape and background component BG with dotted hatching. An amplitude of return light component 50 is smaller than amplitude of first pulse Pa.

Here, it is assumed that a time difference between rising edges of first pulse Pa and return light component S0 is Δt. Δt is time necessary for invisible light to travel back and forth distance dt from imaging apparatus 200 to target T.

The second exposure starts at the same time as second pulse Pb and ends after exposure time Tx. The second exposure aims to receive return light components for second pulse Pb.

Output Ob of image sensor 220 based on the second exposure includes partial return light component S₁ (refer to a hatched portion of a diagonal lattice shape) rather than all return light components and background component BG with dotted hatching.

Above-described component S₁ is represented by following equation (1).

S₁=S₀×(Δt/Wa) (1)

The third exposure starts at timing that does not include return light components of first pulse Pa and second pulse Pb and ends after exposure time Tx. The third exposure aims to receive only background component BG which is an invisible light component irrelevant to the return light component.

Output Oc of image sensor 220 based on the third exposure includes only background component BG with dotted hatching.

Distance dt from imaging apparatus 200 to target T can be derived from a relationship between the emission light and the return light described above by following equations (2) to (4).

S₀=Oa−BG (2)

S₁=Ob−BG (3)

dt=c×(Δt/2)={(c×Wa)/2}×(Δt/Wa)={(c×Wa)/2}×(S₁/S₀) (4)

Here, c is speed of light.

In addition, in the present embodiment, image sensor 220 generates an image signal by adding information of a plurality of pixels adjacent to each other, and performs a so-called lattice transformation. However, in the present disclosure, generating the image signal by adding the information of the plurality of pixels adjacent to each other is not essential.

Distance measurer 120 extracts feature points of a parked vehicle located on a side of vehicle V from an infrared image or a distance image received from image sensor 220, specifies pixels corresponding to the feature points in the distance image, and derives a distance to the feature points based on distance information included in the distance image. The feature points are points previously determined according to a predetermined rule, and, for example, in a vehicle, the feature points are a portion with a high reflectivity of a light wave, such as a headlight or a doorknob, and a portion spaced apart from the portion by a predetermined distance.

Identifier 130 identifies a parkable space based on the distance to the feature point derived by distance measurer 120.

Storage section 140 stores various types of information used for distance measurement processing and identification processing.

A signal relating to the parkable space is output from surrounding monitoring system 1. The information is transmitted to, for example, an advanced driver assistance system (ADAS) ECU. The ADAS ECU performs automated parking of vehicle V using the information.

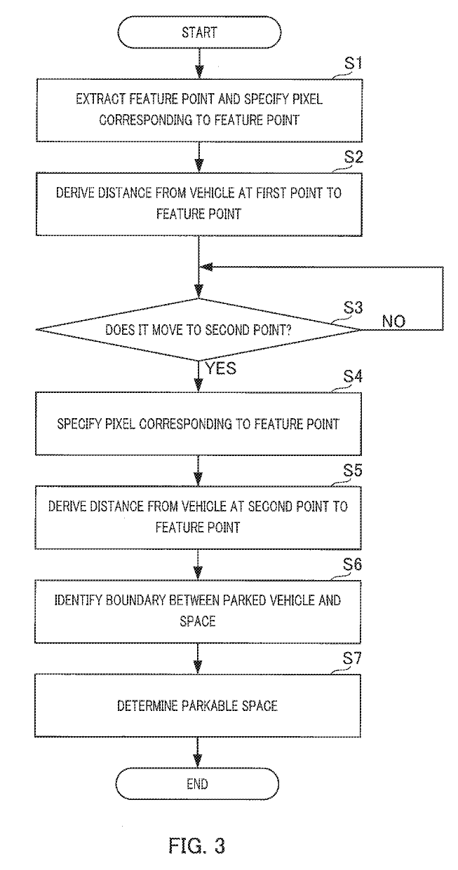

Next, the distance measurement processing and the identification processing performed by distance measurer 120 and identifier 130 of identification apparatus 100 will be described in detail with reference to a flowchart illustrated in FIG. 3.

First, in Step S1, distance measurer 120 extracts a plurality of feature points Ci (i=1 to N: N is a natural number) of parked vehicle P from an infrared image or a distance image received from image sensor 220 and specifies pixel P₁i corresponding to feature point Ci in the distance image. At a point of time of performing processing of step S1, vehicle V exists at a first point. Unlike a stereo camera, the TOF camera does not have a pixel shift of a target between the infrared image and the distance image. Accordingly, even if feature point Ci is extracted from either image, pixel locations on a screen are the same, and it is a matter of course that there is no change in effects described in the present embodiment.

In following step S2, distance measurer 120 derives a distance from vehicle V to feature point Ci based on the distance information of pixel P₁i specified in step S1. In the following description, a “distance from vehicle V to feature point Ci” has the same meaning as a “distance from imaging apparatus 200 to feature point Ci”.

In the present embodiment, a distance from vehicle V to feature point Ci is derived by using distance information of a plurality of pixels existing above and below pixel P₁i in the distance information and the distance image of the pixel P₁i.

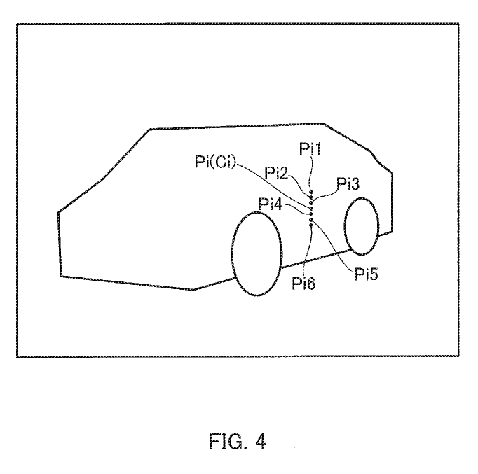

This is due to the following reason. In the distance image obtained by imaging parked vehicle P using imaging apparatus 200 illustrated in FIG. 4, the distance information of pixel Pi corresponding to feature point Ci includes an error caused by intensity of a light wave emitted from light source 210 and intensity of the reflected wave from parked vehicle P.

Accordingly, by using together several pieces of the distance information of a plurality of pixels Pi1 to Pi6 existing above and below pixel Pi, which is considered to have approximately the same distance information as pixel Pi, the distance from vehicle V to feature point Ci is regarded as having a predetermined range. It is a matter of course that, in a case where a coordinate system of an image sensor does not coincide with a coordinate system of a target, the coordinate system is adjusted by correcting yaw, pitch, and roll, and thereafter, when pixels located above and below pixel Pi corresponding to feature point Ci are extracted, closest pixels may be selected or may be estimated from information of peripheral pixels.

In step S3 subsequent to step S2, distance measurer 120 determines whether or not vehicle V moves from the first point described above to a predetermined second point.

If it is determined in step S3 that vehicle V does not move to the second point (step S3: NO), processing of step S3 is repeated.

Meanwhile, if it is determined in step S3 that vehicle V moves to the second point (step S3: YES), the processing proceeds to step S4.

In step S4, distance measurer 120 specifies pixel P2i corresponding to feature point Ci of parked vehicle P in the infrared image or the distance image received from image sensor 220.

In step S5, distance measurer 120 derives a distance from vehicle V to feature point Ci based on the distance information of pixel P₂i specified in step S4. Also at this time, in the same manner as in step S2, distance measurer 120 uses several pieces of distance information of a plurality of pixels existing above and below pixel P₂i in the pixel P₂i and the distance image.

In following step S6, identifier 130 identifies a boundary between parked vehicle P and a space, based on a distance to vehicle V at the first point derived by distance measurer 120 feature point Ci of parked vehicle P, and a distance from vehicle V at the second point to feature point Ci of parked vehicle P. A method of identifying the boundary between parked vehicle V and the space will be described in detail in the following specific examples.

In subsequent step S7, identifier 130 determines a parkable space.

Next, a first specific example of determination of the parkable space performed by identification apparatus 100 will be described with reference to FIG. 5A and FIG. 5F. FIGS. 5A to 5F are top diagrams illustrating a state where vehicle V moving in a parking space detects a parkable space. In the first specific example which will be described below, it is assumed that the parkable space adjacent to parked vehicle P is determined when vehicle V moves forward in a situation where there is one parked vehicle P on the side of vehicle V.

As illustrated in FIG. 5A, a light wave is emitted toward a side of vehicle V. In FIGS. 5A and 5C, a region where the light wave is emitted is indicated by a hatched portion, for example, a field of view (FOV) of the light wave emitted from imaging apparatus 200 in the horizontal direction is 120°, and the FOV can be randomly set.

In the state illustrated in FIG. 5A, parked vehicle V is parked at the first point while vehicle V travels, and parked vehicle P is parked on the diagonal right front with respect to a travel direction of vehicle V. The light wave emitted from imaging apparatus 200 is reflected from a front surface and a left side surface of parked vehicle P.

Distance measurer 120 extracts feature points C1 to C9 of the front surface and the left side surface of parked vehicle P from the infrared image or the distance image obtained by imaging apparatus 200 and determines pixels P₁i_{C1} to P₁i_{C9} corresponding to feature points C1 to C9.

C3 is a feature point corresponding to a front side end when viewed from imaging apparatus 200 on the left side surface of parked vehicle P, and C9 is a feature point corresponding to a back side end on the left side surface of the vehicle P when viewed from imaging apparatus 200 on the left side surface of parked vehicle P.

Subsequently, distance measurer 120 derives distances from vehicle V to feature points C1 to C9 using the distance image. Specifically, distance measurer 120 derives distances from vehicle V to feature points C1 to C9 from the pixels P₁i_{C1} to P₁i_{C9} and the distance image corresponding to feature points C1 to C9, based on the distance information of the plurality of pixels existing in the vertical direction of the pixels. The derived distances from vehicle V to feature points C1 to C9 are values having a predetermined range.

Subsequently, distance measurer 120 estimates locations (first estimated locations) of feature points C1 to C9 based on the derived distances from vehicle V to feature points C1 to C9. FIG. 5B is a top diagram on which the first estimated locations of feature points C1 to C9 are plotted. As illustrated in FIG. 5B, the first estimated locations of feature points C1 to C9 are denoted as line segments L1_{C1} to L1_{C9}. Since the distance information of each pixel includes a noise component such as a shot noise, an error is included in the actual distance. Since the pixels existing in the vertical direction of the feature point are the same in azimuth angle from imaging apparatus 200, the respective line segments L1C1 to L1C9 can be obtained by connecting the pixel with the minimum distance and the pixel with the maximum distance among the pixels.

If vehicle V continues to travel and reaches the second point (FIG. 5C), distance measurer 120 determines pixels P₂i_{C1} and P₂i_{C9} corresponding to C1 to C9 in the infrared image or the distance image obtained by imaging apparatus 200. It is a matter of course that, when vehicle V moves from the first point to the second point, the amount of movement may be calculated from vehicle speed information and steering angle information of vehicle V. In addition to this, it is a matter of course that the amount of movement described above may be estimated from a sensor such as a millimeter-wave radar, a sonar, or a camera, and may be estimated from the image information of the TOF camera.

Distance measurer 120 derives the distance from vehicle V to feature points C1 to C9 using the distance image. Specifically, distance measurer 120 derives the distances from vehicle V to feature points C1 to C9 from pixels P₂i_{C1} to P₂i_{C9} corresponding to feature points C1 to C9 and the distance image, based on the distance information of the plurality of pixels existing in the vertical direction of the pixel. The distance, which is derived by doing so, from vehicle V to feature points C1 to C9 are values having a predetermined range.

In the first specific example, the second point is a point where imaging apparatus 200, feature points C3, and feature point C9 do not exist in a straight line. In other words, the second point exists in a range in which a light wave emitted from imaging apparatus 200 is reflected from a side surface of parked vehicle P. In this case, the second point is at a location in which the TOF camera mounted on vehicle V comes before a location where a left side outline of parked vehicle P exists. This means that it is possible to accurately estimate an outline of the parked vehicle before passing through a vehicle to be parked when searching for a parking space. That is, timing to apply a vehicle control when automatic parking is performed can be set before reaching the vehicle to be parked, and it is possible to expect a dramatic increase in a degree of freedom in setting the vehicle control of the automatic parking.

Subsequently, distance measurer 120 estimates locations (second estimated locations) of feature points C1 to C9 based on the derived distances from vehicle V to feature points C1 to C9. FIG. 5D is a top diagram on which the second estimated locations of feature points C1 to C9 are plotted. The second estimated locations of feature points C1 to C9 are denoted by line segments L2_{C1} to L2_{C9}.

Identifier 130 identifies a boundary between parked vehicle P and a space, based on the distances from imaging apparatus 200 to feature points C1 to C9 at the first point derived as described above and the distance from imaging apparatus 200 to feature points C1 to C9 at the second point.

For example, FIG. 5E is obtained by overlapping FIG. 5B with FIG. 5D. Line segments L1_{C1} to L1_{C9} indicating the first estimated locations of feature points C1 to C9 in FIG. 5B and line segments L2_{C1} to L2_{C9} indicating the second estimated locations of feature points C1 to C9 in FIG. 5D intersect each other at intersection points I_{C1} to I_{C9}, respectively, as illustrated in FIG. 5E.

Identifier 130 determines that intersection point I_{C1} between line segment L1_{C1} indicating feature point C1 in FIG. 5B and line segment L2_{C1} indicating feature point C1 in FIG. 5D is a location of feature point C1. The same is applied to locations of feature points C2 to C9.

Then, identifier 130 determines the boundary between parked vehicle P and the space by connecting the locations of feature points C1 to C9 determined in the above-described sequence. Feature point C9 is a feature point corresponding to a back side end of parked vehicle P when viewed from imaging apparatus 200. Accordingly, identifier 130 determines a rear surface of parked vehicle P based on feature point C9.

FIG. 5F illustrates a state where a front surface, a left side surface, and a rear surface of parked vehicle P are determined. As such, it is possible to accurately determine the left side surface of parked vehicle P by using the distance measurement information at the first point and the second point sufficiently obtaining the reflected light from the left side surface of parked vehicle P. The right side surface of parked vehicle P can also be determined by the same sequence as the sequence for determining the left side surface. Specifically, it is possible to determine the right side surface of parked vehicle P by using the distance measurement information on a point (first point) where, when vehicle V continues to move forward, imaging apparatus 200 reaches by exceeding the right side surface of parked vehicle P, and the distance measurement information on a point (second point) where vehicle V reaches by further continuing movement.

If the outline of parked vehicle P (the boundary between parked vehicle P and the space) is determined by doing so, identifier 130 detects that there is no obstacle that vehicle V cannot overcome on the left side and/or the right side of parked vehicle P, based on the information from the TOF camera. Furthermore, identifier 130 detects that there is a rectangular space (that is, a space into which vehicle V enters), for example, in a plan view, in which vehicle V can park on the left side and/or the right side of parked vehicle P. Identifier 130 finally determines a parkable space adjacent to the left side and/or the right side of parked vehicle P as described above.

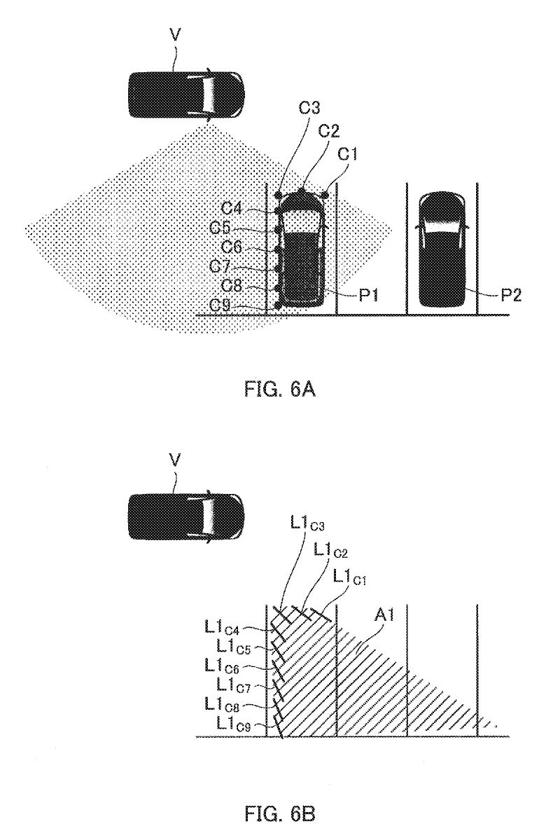

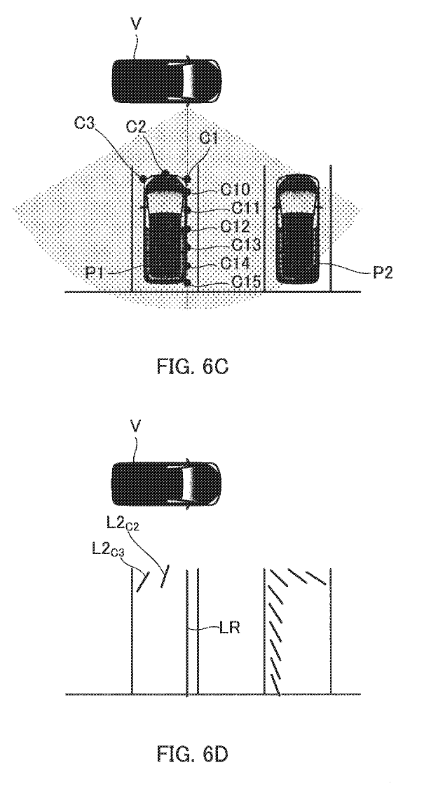

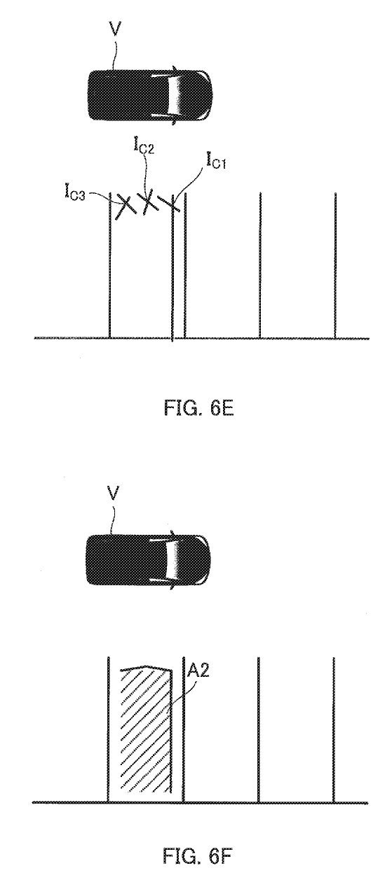

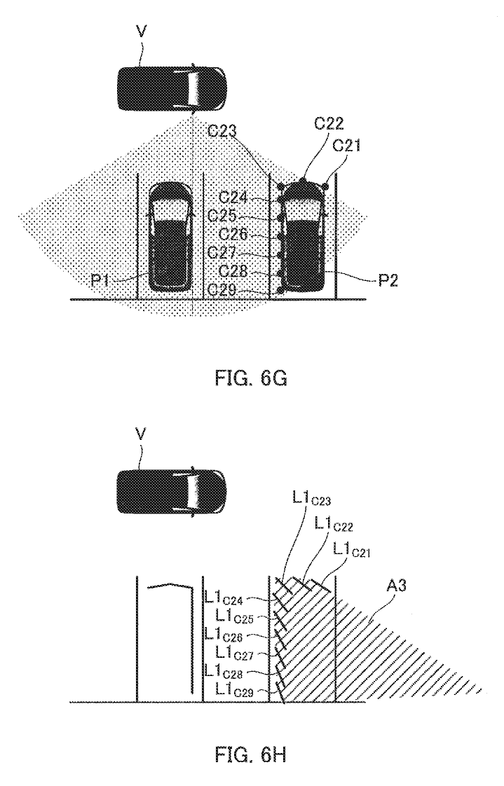

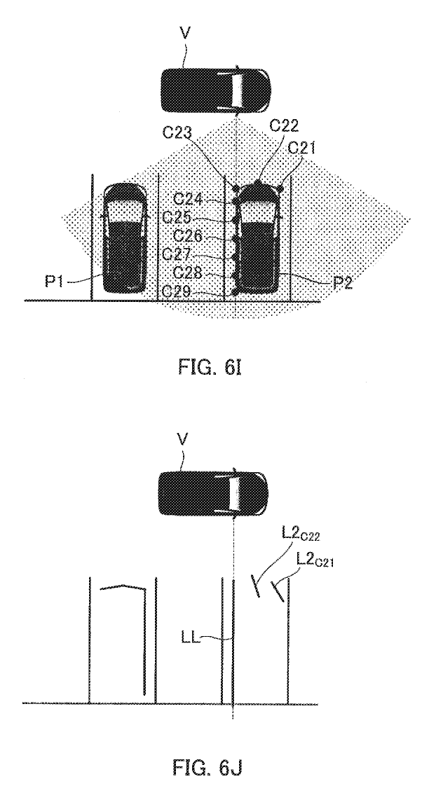

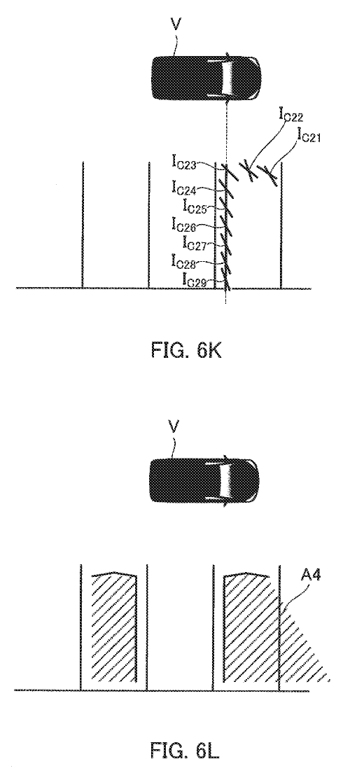

Next, a second specific example of determining the parkable space performed by identification apparatus 100 will be described with reference to FIGS. 6A to 6H. FIGS. 6A to 6H are top diagrams illustrating states where vehicle V moving within the parking space detects a parkable space. In the second specific example which will be described below, it is assumed that, in a situation where two parked vehicles P1 and P2 exist at intervals on the side of vehicle V, when vehicle V moves forward, a parkable space between parked vehicle P1 and parked vehicle P2 is determined.

As illustrated in FIG. 6A, light waves are emitted toward the side of vehicle V. In FIGS. 6A, 6C, 6G, and 6I, regions where the light waves are emitted are illustrated with hatching. For example, the field of view (FOV) of the light waves, which are emitted from imaging apparatus 200, in the horizontal direction is 120°. The FOV can be set randomly.

In the state illustrated in FIG. 6A, vehicle V is at the first point with respect to parked vehicle P1 while moving forward and parked vehicle P1 is parked at a diagonally right forward portion with respect to a travel direction of vehicle V. Furthermore, parked vehicle P2 is parked on the right side of the parked vehicle P at intervals. The light waves emitted from imaging apparatus 200 are reflected from the front surface and the left side surface of parked vehicle P1.

Distance measurer 120 extracts feature points C1 to C9 on the front surface and the left side surface of parked vehicle P1 from the infrared image or the distance image obtained by imaging apparatus 200 and determines pixels P₁i_{C1} to P₁i_{C9} corresponding to feature points C1 to C9.

C3 is a feature point corresponding to a front side end when viewed from imaging apparatus 200 on the left side surface of parked vehicle P1, and C9 is a feature point corresponding to the back side end when viewed from imaging apparatus 200 on the left side surface of parked vehicle P1.

Subsequently, distance measurer 120 derives the distances from vehicle V to feature points C1 to C9 using the distance image. Specifically, distance measurer 120 derives the distances from vehicle V to feature points C1 to C9, based on the distance information of the plurality of pixels existing in the vertical direction of the pixels in the pixels P₁i_{C1} to P₁i_{C9} corresponding to feature points C1 to C9 and the distance image. The distances, which are derived by doing so, from vehicle V to feature points C1 to C9 are values having a predetermined range.

Subsequently, distance measurer 120 estimates locations (first estimated locations) of feature points C1 to C9 based on the derived distances from vehicle V to feature points C1 to C9. FIG. 6B is a top diagram on which the first estimated locations of feature points C1 to C9 are plotted. As illustrated in FIG. 6B, the first estimated locations of feature points C1 to C9 are denoted as line segments L1_{C1} to L1_{C9}. At this point of time, hatched area A1 is set as a parking prohibition area.

If vehicle V continues to move forward, imaging apparatus 200 enters a state of being present on a substantially extended line of the right side surface of parked vehicle P1 (FIG. 6C). In the present example, such a point is treated as a second point for parked vehicle P1. Such a state can be determined by obtaining the distance information in a depth direction when viewed from imaging apparatus 200.

Distance measurer 120 extracts feature points C1 to C3 and C10 to C15 on the front surface and the right side surface of parked vehicle P1 from the infrared image or the distance image obtained by imaging apparatus 200 and determines pixels P₂i_{C1} to P₂i_{C3} and P₂i_{C10} to P₂i_{C15} corresponding to feature points C1 to C3 and C10 to C15. In this state, in the infrared image or the distance image obtained by imaging apparatus 200, feature points C10 to C15 overlap feature point C1 or exist at a very close place to feature point C1.

Distance measurer 120 derives the distances from vehicle V to feature points C1 to C3 and C10 to C15 using the distance image. Specifically, distance measurer 120 derives the distances from vehicle V to feature points C1 to C3 and C10 to C15, based on the distance information of the plurality of pixels existing in the vertical direction of the pixels in the pixels P₂i_{C1} to P₂i_{C3} and P₂i_{C10} to P₂i_{C15} corresponding to feature points C1 to C3 and C10 to C15 and the distance image. The distances, which are derived by doing so, from vehicle V to feature points C1 to C3 and C10 to C15 are values having a predetermined range.

Subsequently, distance measurer 120 estimates the locations (second estimated locations) of feature points C1 to C3 and C10 to C15, based on the derived distances from vehicle V to feature points C1 to C3 and C10 to C15. FIG. 6D is a top diagram on which the second estimated locations of feature points C1 to C3 and C10 to C15 are plotted.

In the second specific example, boundary line LR connecting feature points C3, and C10 to C 15 is determined by setting a state where feature points C3, and C10 to C15 are on a substantially straight line as the second point, as illustrated in FIG. 6D. Boundary line LR corresponds to the right side surface of parked vehicle P1.

Identifier 130 identifies a boundary between parked vehicle P1 and the space, based on the distances from vehicle V at the first point derived by doing as described above to feature points C1 to C9, and the distances from vehicle V at the second point to feature points C1 to C3 and C10 to C15.

For example, FIG. 6E is obtained by overlapping FIG. 6B with FIG. 6D. Line segments L1_{C2} and L1_{C3} indicating the first estimated locations of feature points C2 and C3 in FIG. 6B and line segments L2_{C2} and L2_{C3} indicating the second estimated locations of feature points C2 and C3 in FIG. 6D intersect at intersection points I_{C2} and I_{C3}, respectively, as illustrated in FIG. 6E.

In addition, line segment L1_{C1} indicating the first estimated location of feature point C1 in FIG. 6B, and boundary line LR indicating the right side surface of parked vehicle P1 in FIG. 6D intersect at intersection point Ici as illustrated in FIG. 6E.

Identifier 130 determines the boundary between parked vehicle P1 and the space by connecting the intersection point of line segments L1_{C2} and L1_{C3} and line segments L2_{C2} and L2_{C3} and the intersection point of line segment L1_{C1} and boundary line LR. FIG. 6F illustrates a state where the front surface and the right side surface of parked vehicle P1 are determined. At this point of time, the parking prohibition area is set to area A2, and areas relating to the front surface and the right side surface of parked vehicle P1 are optimized.

At this time, as illustrated in FIG. 6C, the light waves emitted from imaging apparatus 200 are also reflected from the front surface and the left side surface of parked vehicle P2. That is, in the state of FIG. 6C, vehicle V exists at the first point with respect to parked vehicle P2. Distance measurer 120 extracts feature points C21 to C29 on the front surface and the left side surface of parked vehicle P2 from the infrared image or the distance image obtained by imaging apparatus 200 and determines pixels P₁i_{C21} to P₁i_{C29} corresponding to feature points C21 to C29 (see FIG. 6G).

C23 is a feature point corresponding to the front side end of imaging apparatus 200 on the left side surface of parked vehicle P2, and C29 is a feature point corresponding to the back side end when viewed from imaging apparatus 200 on the left side surface of parked vehicle P2.

Subsequently, distance measurer 120 derives distances from vehicle V to feature points C21 to C29 using the distance image. Specifically, distance measurer 120 derives the distances from vehicle V to feature points C21 to C29, based on the distance information of the plurality of pixels existing in the vertical direction of the pixels in the pixels P₁i_{C21} to P₁i_{C29} corresponding to feature points C21 to C29 and the distance image. The distances, which are thus derived by doing so, from vehicle V to feature points C21 to C29 are values having a predetermined range.

Subsequently, distance measurer 120 estimates the locations (the first estimated locations) of feature points C21 to C29, based on the derived distances from vehicle V to feature points C21 to C29. FIG. 6H is a top diagram on which the first estimated locations of feature points C21 to C29 are plotted. As illustrated in FIG. 6H, the first estimated locations of feature points C21 to C29 are denoted as line segments L1_{C21} to L1_{C29}. At this point of time, hatched area A3 is set as the parking prohibition area.

If vehicle V further continues to move forward, imaging apparatus 200, feature point C23, and feature point C29 exist in a substantially straight line (FIG. 6I). In the present example, this point is treated as the second point for parked vehicle P2. In this state, in the infrared image or the distance image obtained by imaging apparatus 200, feature points C24 to C29 overlap feature point C23 or exist at a very close place to feature point C23.

Distance measurer 120 determines pixels P₂i_{C21} to P₂i_{C29} corresponding to pixels C23 to C29 in the infrared image or the distance image obtained by imaging apparatus 200.

Distance measurer 120 derives the distances from vehicle V to feature points C21 to C29 using the distance image. Specifically, the distance measurer 120 derives the distances from vehicle V to feature points C21 to C29, based on the distance information of the plurality of pixels existing in the vertical direction of the pixels in the pixels P₂i_{C21} to P₂i_{C29} corresponding to feature points C21 to C29 and the distance image. The distances, which are derived by doing so, from vehicle V to feature points C21 to C29 are values having a predetermined range.

Subsequently, distance measurer 120 estimates the locations (second estimated locations) of feature points C21 to C29, based on the derived distances from vehicle V to feature points C21 to C29. FIG. 6J is a top diagram on which the second estimated locations of feature points C21 to C29 are plotted.

In the present example, boundary line LL connecting feature points C23 to C29 is determined by setting a state where feature point C23 and feature point C29 are on a substantially straight line as the second point, as illustrated in FIG. 6J. Boundary line LL corresponds to the left side surface of parked vehicle P2.

Identifier 130 identifies a boundary between parked vehicle P2 and the space, based on the distances from vehicle V to feature points C21 to C29 at the first point derived by doing as described above and the distances from vehicle V at the second point to feature points C21 to C29.

For example, FIG. 6K is obtained by overlapping FIG. 6H with FIG. 6J. L1_{C21} and L1_{C22} indicating the first estimated locations of feature points C21 and C22 in FIG. 6H, and L2_{C21} and L2_{C22} indicating the second estimated locations of feature points C21 and C22 in FIG. 6J intersect at intersection points I_{C21} and I_{C22}, respectively, as illustrated in FIG. 6K.

Line segments L1_{C23} to L1_{C29} indicating the first estimated locations of feature points C23 to C29 in FIG. 6H and boundary line LL indicating the left side surface of parked vehicle P2 in FIG. 6J intersect at intersection points I_{C23} to I_{C29}, respectively, as illustrated in FIG. 6K.

In addition, feature point C29 is a feature point corresponding to the back side end of parked vehicle P2 when viewed from imaging apparatus 200. Accordingly, identifier 130 determines the rear end of parked vehicle P2, based on feature point C29. FIG. 6L illustrates a state where the front surface and the left side surface of parked vehicle P2 are determined. At this point, the parking prohibition area is set to area A4 and the area relating to the left side surface and the front surface of parked vehicle P2 is optimized.

If the outlines of parked vehicles P1 and P2 are determined by doing so, identifier 130 further detects that there is no obstacle that vehicle V cannot overcome between the right side of parked vehicle P1 and the left side of parked vehicle P2, based on the information from the TOF camera. Furthermore, identifier 130 detects that there is a rectangular space (that is, a space into which vehicle V enters), for example, in a plan view, in which vehicle V can park between the right side of parked vehicle P1 and the left side of parked vehicle P2. As described above, identifier 130 finally determines a parkable space between parked vehicles P1 and P2.

In the example described above, it is described that, regarding parked vehicle P1, a point at which imaging apparatus 200 exists on the substantially extended line of the right side surface of parked vehicle P1 is set as the second point, and vehicle V uses the distance measurement information at the first point and the distance measurement information at the second point, but the example is not limited to this.

It is considered that vehicle V may not sufficiently obtain light reflected from the right side surface of parked vehicle P1 depending on a body color, a structure, and the like of parked vehicle P1 at a point where imaging apparatus 200 exists on a substantially extended line of the right side surface of parked vehicle P1. Likewise, even at a point where the vehicle slightly moves forward therefrom, the light reflected from the right side surface of parked vehicle P1 is not sufficient, and thus, it is conceivable that parked vehicle P1 is erroneously estimated not to exist in an area where parked vehicle P1 actually exists. In such a case, the parking prohibition area may be underestimated.

In contrast to this, for example, when vehicle V further moves forward, an angle between imaging apparatus 200 and parked vehicle P1 increases to some extent and a point where the light reflected from the right side surface of parked vehicle P1 is sufficiently obtained is set as a third point relating to parked vehicle P, and it is conceivable to perform distance measurement even at the third point. For example, the second point relating to parked vehicle P2 can be used As the third point.

By doing so, it is possible to prevent erroneously estimating that there is no parked vehicle P1 in an area where parked vehicle P1 exists and to preferably prevent the parking prohibition area from being underestimated.

That is, in addition to the distance measurement information on the first point where imaging apparatus 200 and the side surface of the parked vehicle do not exist in a straight line, and the second point where imaging apparatus 200 and the side surface of the parked vehicle exist in a substantially straight line, by further using the distance measurement information on the third point where imaging apparatus 200 and the side surface of the parked vehicle do not exist in a straight line, an identification accuracy can be improved.

As described above, the identification apparatus according to the present disclosure includes an inputter that receives first distance image information which is obtained by imaging an object from a first point using an imaging apparatus and second distance image information which is obtained by imaging the object from a second point different from the first point using the imaging apparatus, a distance measurer that derives first distance information from the first point to a plurality of feature points of the object based on the first distance image information and derives second distance information from the second point to the plurality of feature points based on the second range image information, an identifier that identifies a boundary between the object and a space based on the first distance information and the second distance information, and an outputter that outputs identification results of the identifier to an external apparatus.

According to an identification apparatus relating to the present disclosure, a boundary between an object and a space can be accurately identified.

In the above-described embodiment, examples of identifying a boundary between a parked vehicle and a space are described, but the embodiment is not limited to this. It is also possible to identify a boundary between an obstacle such as a shopping cart left in a parking space and a space. In the present embodiment, a specific example of accurately estimating a parkable space using images captured at a first point, a second point, and a third point is described, but the present invention is not limited thereto. It goes without saying that it is possible to estimate the parking space with a higher accuracy by using images captured at more points. However, since the amount of calculation increases by using more images, if it is possible to accurately obtain the boundary between the parking space and the parked vehicle, it is apparent that the smaller the used images, the better.

While various embodiments have been described herein above, it is to be appreciated that various changes in form and detail may be made without departing from the spirit and scope of the invention(s) presently or hereafter claimed.

This application is entitled and claims the benefit of Japanese Patent Application No. 2018-060306, filed on Mar. 27, 2018, the disclosure of which including the specification, drawings and abstract is incorporated herein by reference in its entirety.

### INDUSTRIAL APPLICABILITY

According to an identification apparatus, an identification method, and a non-transitory recording medium storing an identification program relating to the present disclosure, it is possible to accurately identify a boundary between an object and a space, which is suitable for on-vehicle use.

### REFERENCE SIGNS LIST

1 Surrounding monitoring system
100 Identification apparatus
110 Imaging controller
120 Distance measurer
130 Identifier
140 Storage section
200 Imaging apparatus
210 Light source
220 Image sensor
V Vehicle
P, P1, P2 Parked vehicle

1. An identification apparatus, comprising:
circuitry that receives first distance image information obtained by imaging an object from a first point, using an imaging apparatus, and second distance image information obtained by imaging the object from a second point different from the first point, using the imaging apparatus;
derives first distance information from the first point to a plurality of feature points of the object based on the first distance image information and derives second distance information from the second point to the plurality of feature points based on the second distance image information;
identifies a boundary between the object and a space based on the first distance information and the second distance information; and
outputs an identification result from the identifying to an external apparatus.

2. The identification apparatus according to claim 1, wherein
the circuitry extracts the feature point from the first distance image information, specifies a first pixel corresponding to the feature point in the first distance image information, and derives the first distance information based on distance information of the first pixel, and
extracts the feature point from the second distance image information, specifies a second pixel corresponding to the feature point in the second distance image information, and derives the second distance information based on distance information of the second pixel.

3. The identification apparatus according to claim 2, wherein
the circuitry derives the first distance information based on distance information of the first pixel and a plurality of pixels existing above and below the first pixel, and
derives the second distance information based on distance information of the second pixel and a plurality of pixels existing above and below the second pixel.

4. The identification apparatus according to claim 2, wherein
the circuitry derives the first distance information at the first point and derives the second distance information at the second point.

5. The identification apparatus according to claim 1, wherein
the plurality of feature points include a first feature point corresponding to a front side end of the object and a second feature point corresponding to a back side end of the object as viewed from the imaging apparatus, wherein
the first point and the second point are both points where the imaging apparatus, the first feature point, and the second feature point do not exist on a straight line, and wherein
the circuitry estimates a first estimated location of each of the plurality of feature points based on the first distance information and estimates a second estimated location of each of the plurality of feature points based on the second distance information,
specifies each location of the plurality of feature points based on the first estimated location and the second estimated location, and
identifies the boundary between the object and the space based on the specified locations of the plurality of feature points.

6. The identification apparatus according to claim 1, wherein
the plurality of feature points include a first feature point corresponding to a front side end of the object and a second feature point corresponding to a back side end of the object as viewed from the imaging apparatus, wherein
the first point is a point where the imaging apparatus, the first feature point, and the second feature point do not exist on a straight line, and
the second point is a point where the imaging apparatus, the first feature point, and the second feature point exist on a substantially straight line, and wherein
the circuitry estimates each estimated location of the plurality of feature points based on the first distance information and determines a boundary line connecting the plurality of feature points to each other based on the second distance information,
specifies each location of the plurality of feature points based on the estimated location and the boundary line, and
identifies the boundary between the object and the space based on the specified locations of the plurality of feature points.

7. The identification apparatus according to claim 6, wherein
the circuitry further receives third distance information from a third point different from the first point and the second point to the plurality of feature points, and
identifies the boundary between the object and the space based on the first distance information, the second distance information, and the third distance information.

8. An identification method, comprising:
receiving first distance image information obtained by imaging an object from a first point, using an imaging apparatus and second distance image information obtained by imaging the object from a second point different from the first point, using the imaging apparatus;
deriving first distance information from the first point to a plurality of feature points of the object based on the first distance image information and deriving second distance information from the second point to the plurality of feature points based on the second distance image information;
identifying a boundary between the object and a space based on the first distance information and the second distance information; and
outputting an identification result in the identifying to an external apparatus.

9. A non-transitory recording medium storing an identification program causing a computer to execute processing comprising:
receiving first distance image information obtained by imaging an object from a first point using an imaging apparatus and second distance image information obtained by imaging the object from a second point different from the first point using the imaging apparatus;
deriving first distance information from the first point to a plurality of feature points of the object based on the first distance image information and deriving second distance information from the second point to the plurality of feature points based on the second distance image information;
identifying a boundary between the object and a space based on the first distance information and the second distance information; and
outputting an identification result in the processing of identifying to an external apparatus.
